(19) United States
(12) Patent Application Publication
(10) Pub. No.: US 2020/0247251 A1
(43) Pub. Date: Aug. 6, 2020

(54) INTELLIGENT POWER WIRELESS CHARGING SYSTEM FOR ELECTRIC WHEELCHAIRS

(71) Applicant: Lam Wing Ming, Hong Kong (HK)

(72) Inventor: Lam Wing Ming, Hong Kong (HK)

(21) Appl. No.: 16/264,690

(22) Filed: Feb. 1, 2019

(51) Int. Cl. B60L 53/126; H02J 7/02; H02J 50/80; H02J 50/90; B60L 53/38

(52) U.S. Cl. CPC B60L 53/126; H02J 7/025; H02J 50/80; B60L 2200/24; H02J 50/90; B60L 53/38; H02J 7/027

(57) ABSTRACT

An intelligent power wireless charging system for electric wheelchairs, comprises: a wireless charging transmitter, the transmitter has a transmitter host and a manipulator with a transmitter pad; a wireless charging receiver installed in the electric wheelchair; when the electric wheelchair is driven to the transmitter host within a certain area, the transmitter host receives the signal from the wireless charging receiver, a laser sensor of the transmitter host detects the position of the electric wheelchair, a laser transmitter of the transmitter host emits reference lines for guiding the electric wheelchair is parked within the predefined charging parking area; the manipulator is activated and carries the transmitter pad from the standby position to move to the predefined waiting for charging position; the laser sensor of the transmitter pad is activated and detects the position of the electric wheelchair, the manipulator automatically find the wireless charging receiver to charge; when the charging is completed, the manipulator automatically returns to the standby position.

### FIELD OF THE INVENTION

The present invention generally relates to the technical field of power charging, and more particularly to an intelligent power wireless charging system for electric wheelchairs.

### BACKGROUND OF THE INVENTION

Elderly people or person with physical disability may have limited mobility due to old age and other factors requiring them to use devices such as electric wheelchairs to maneuver around areas. These electric wheelchairs need to be charged periodically to have enough energy to function throughout the day. Charging the electric wheelchairs requires the person to make a number of physical movements. However, this is a difficult task for the people with limited mobility.

A U.S. Pat. No. 5,617,003 disclosed a method and apparatus for charging a battery of an electric vehicle. The method and apparatus of charging a battery of an electric vehicle through inductive coupling between a primary inductive device having a core and a primary coil connected to a power source and a secondary inductive device having a core and a secondary coil connected to the battery are disclosed. The primary inductive device is provided on a movable arm of a ground charger unit and the secondary inductive device is mounted on the bottom of the vehicle adjacent its rear end. The power source supplies to the primary coil selectively a charging current and a check current. When the check current is supplied to the primary coil, an electromotive force is induced in the secondary coil which varies with a change of the relative position between the primary and secondary inductive devices. The variation in the induced electromotive force causes a change of the check current flowing in the primary coil. The position where the primary inductive device should be placed with respect to the secondary inductive device just before coupling thereof is determined on the basis of the change of the check current which is monitored while moving the primary inductive device relative to the secondary inductive device.

Apparently, by connecting the charger and the handle with the receiver to each other by magnet attraction, the handle with the receiver must be brought very close to the charger. For people with limited mobility, it is still very inconvenient.

Another U.S. Pat. No. 9,739,844B2 disclosed a guidance and alignment systems for wireless charging to assist in aligning the transmitter and receiver inductive power transfer (IPT) couplers. These systems guide positioning and alignment to provide sufficient coupling between the transmitter and receiver IPT couplers. Exemplary systems provide a magnetic field sensor, magnetic field generator, and magnetic vectoring to determine a position of an electric vehicle or a wireless charging base. In a magnetic vectoring system, an alignment system comprising at least three coils (or similar circuits) on a magnetically permeable substrate receives a positioning magnetic field including modulated information signals and processes the received signal to generate an output for determining a position of the positioning magnetic field source relative to the magnetic field sensor position. The alignment system may further comprise a similar structure that generates the positioning magnetic field that may include modulated information signals, based on input signals.

However, these systems guide positioning and alignment to provide coupling between the transmitter and receiver are all for cars. The battery and the charging type of cars are not suitable for electric wheelchairs based on at least the below reasons:

1. The high-power wireless charging or power supply applied for cars produces large radiation and transmission intensity, so as to seriously affect human health, especially for the people with limited mobility who usually sit on the wheelchair during charging. In addition, the high-power wireless charging also brings environmental pollution, and it is difficult to meet international safety standards.
2. Using this type of guidance and alignment systems for wireless charging, it is necessary to align the center points of the coil of transmitter and the coil of receiver before charging and the error is usually in the millimeter range. This is obviously not an easy thing for the people with limited mobility.
3. Not only need the center point alignment of the coil of transmitter and the coil of receiver, but also need to maintain the appropriate distance between the coil of transmitter and the coil of receiver, otherwise the charging effect will be very affected. Therefore, further aggravating the inconvenience for the people with limited mobility.

### SUMMARY OF THE INVENTION

One object of the present invention is to provide an intelligent power wireless charging system which has an easier and more convenient way of wireless charging for electric wheelchairs.

To achieve the object, the present invention provides an intelligent power wireless charging system for electric wheelchairs, includes: a wireless charging transmitter connected to power supply, the transmitter has a transmitter host and a manipulator with a transmitter pad; a wireless charging receiver installed in the electric wheelchair; when the electric wheelchair is driven to the transmitter host within a certain area, the transmitter host receives the signal from the wireless charging receiver, a laser sensor of the transmitter host detects the position of the electric wheelchair, a laser transmitter of the transmitter host emits reference lines for guiding the electric wheelchair is parked within the predefined charging parking area; after the electric wheelchair is parked within the charging parking area for a certain time, the manipulator is activated and carries the transmitter pad from the standby position to move to the predefined waiting for charging position; after the transmitter pad is paused at the waiting for charging position for a certain time, the laser sensor of the transmitter pad is activated and detects the position of the electric wheelchair, the manipulator automatically find the wireless charging receiver to charge through automatic tracking technology; when the charging is completed, the manipulator automatically returns to the standby position.

In line with the current development of electric wheelchairs on the market, all functions and design purposes are to enable electric wheelchair users to enjoy a more convenient, environmental friendly and safe new lifestyle.

By simply installing the wireless charging receiver in the wheelchair and installing the wireless charging transmitter on the wall or special bracket, it realizes the communication between the electric wheelchair and the wireless charging transmitter, so that the wireless charging can be achieved.

By emitting reference lines on the ground from the laser transmitter of the wireless charging transmitter, it realizes to guide the electric wheelchair to easily park within the predefined charging parking area.

By detecting the position of the electric wheelchair through the laser sensor of the wireless charging transmitter, it helps that the manipulator automatically find the wireless charging receiver to charge through automatic tracking, so that the wireless charging can be achieved more convenient.

By automatic tracking through manipulator, the manipulator carries the transmitter pad gradually close to the wireless charging receiver and finally abuts the wireless charging receiver to realize power charging. When the charging is complete, the manipulator carries the transmitter returns back to the standby position. In addition, the electric wheelchair also can be parked within a certain range in the charging parking area to realize the multi-angle charging.

In summary, it is really convenient for people with limited mobility.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a schematic view of electric wheelchair charging according to the present invention;

FIG. 2 is a schematic view of installing the receiver on the armrest of the electric wheel according to the present invention;

FIG. 3 is a schematic view that the height from the ground to the center point of the receiver according to the present invention;

FIG. 4 is a schematic view that the central point of the transmitter host should be the same height as the central point of the receiver according to the present invention;

FIG. 5 is a schematic view that the front pedal edge of the electric wheelchair near the laser line according to the present invention;

FIG. 6 is a schematic view of rotating the laser knob below the host to align the laser crosshairs to the front pedal edge of the electric wheelchair according to the present invention;

FIG. 7 is a schematic view of the multi-angle charging according to the present invention;

FIG. 8 is a schematic view of the charging parking area according to the present invention;

FIG. 9 is a schematic view of the functional buttons according to the present invention;

FIG. 10 is a schematic view of the electric wheelchair travel range according to the present invention.

### DETAILED DESCRIPTION OF THE INVENTION

The present invention would be further described herein with reference to the accompanying drawings and embodiments of the present invention. While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, terms such as “first,” “second,” “third,” etc., merely identify one of a number of portions, components and/or points of reference as disclosed herein, and do not limit the present invention to any particular configuration or orientation.

The present invention discloses an intelligent power wireless charging system for electric wheelchairs, includes: a wireless charging transmitter connected to power supply, the transmitter has a transmitter host and a manipulator with a transmitter pad; a wireless charging receiver installed in the electric wheelchair; when the electric wheelchair is driven to the transmitter host within a certain area, the transmitter host receives the signal from the wireless charging receiver, a laser sensor of the transmitter host detects the position of the electric wheelchair, a laser transmitter of the transmitter host emits reference lines for guiding the electric wheelchair is parked within the predefined charging parking area; after the electric wheelchair is parked within the charging parking area for a certain time, the manipulator is activated and carries the transmitter pad from the standby position to move to the predefined waiting for charging position; after the transmitter pad is paused at the waiting for charging position for a certain time, the laser sensor of the transmitter pad is activated and detects the position of the electric wheelchair, the manipulator automatically find the wireless charging receiver to charge through automatic tracking technology; when the charging is completed, the manipulator automatically returns to the standby position.

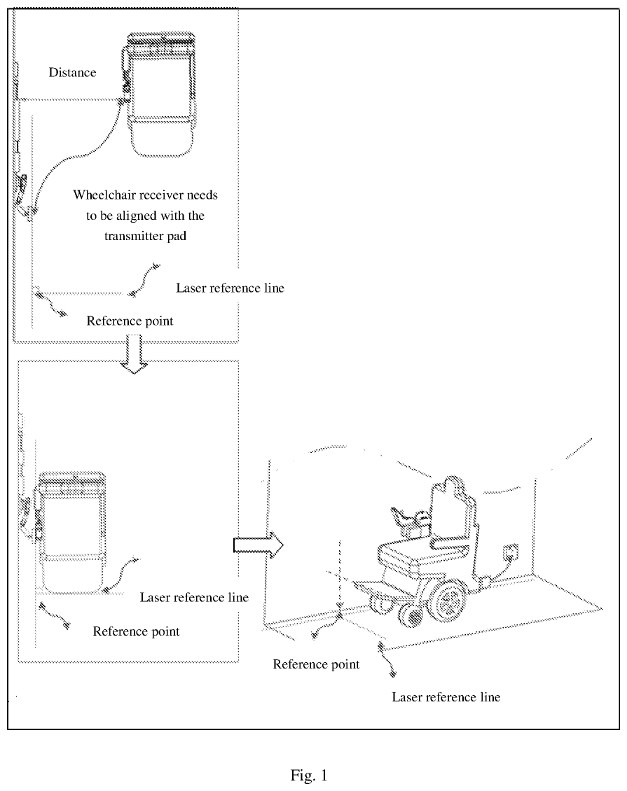

FIG. 1 is a schematic view of electric wheelchair wireless charging according to the present invention. With respect to the intelligent power charging system for electric wheelchairs, the wireless charging transmitter should be connected to the AC power to make this system work. When the wheelchair user drives the electric wheelchair to the transmitter host within a certain area (for example 1 meter), it needs to meet the following three conditions to perform charging:

1. The transmitter host receives the signal (for example Bluetooth communication signal) from the wireless charging receiver installed in the electric wheelchair;
2. The electric wheelchair is parked at the charging parking area; and
3. The electric wheelchair is parked for a certain time.

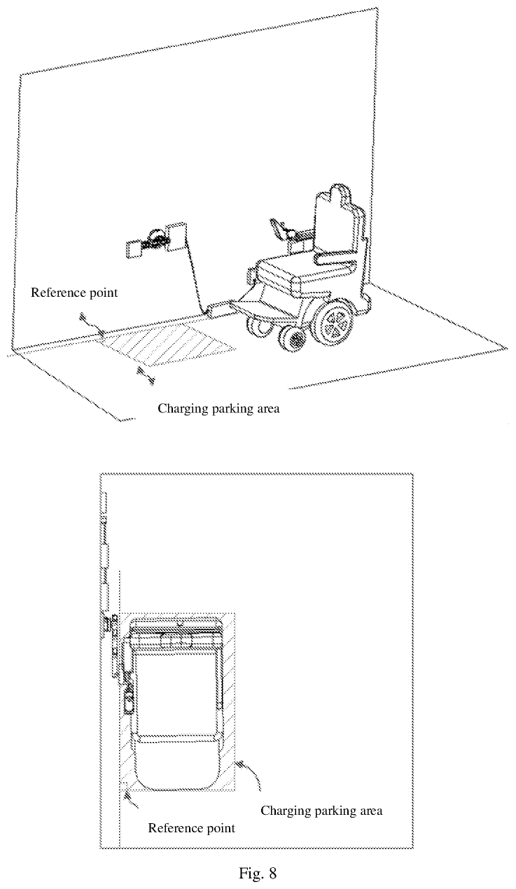

Specifically, the transmitter host receives the Bluetooth communication signal from the wireless charging receiver, the laser sensor of the transmitter host emits laser rays, and the laser rays are reflected back to the laser receiver. The time difference between the laser transmitting and receiving signals is used to calculate the distance between the transmitting and receiving ends. When the transmitter host confirms the electric wheelchair is moved in the charging parking area, the laser transmitter installed at the bottom of the transmitter host emits laser lines and draws laser crosshair on the ground. The laser crosshair is the parking position reference line for the electric wheelchair (FIG. 8). The electric wheelchair user needs to drive the electric wheelchair to the laser crosshair parking reference lines, wait for the transmitter host to further confirm the position of the electric wheelchair, and the electric wheelchair do better not move after parking. The electric wheelchair needs to be parked at the charging parking area for a certain time (for example 5 seconds).

After the transmitter host confirms the above-mentioned three conditions, the manipulator is activated and carries the transmitter pad from the standby position to move to the predefined waiting for charging position.

After the transmitter pad pauses a certain time (for example 2 seconds) at the waiting for charging position, the laser sensor of the transmitter pad is activated and emits laser light to the wireless charging receiver on the electric wheelchair. The laser signal is reflected back from the wireless charging receiver. The laser sensor receiver on the transmitter pad calculates the distance and angle between the transmitting and receiving ends of wireless charging receiver and laser sensor receiver by calculation the time difference between the transmitting and receiving of the laser signal. These analysis data are converted into pulse signals. After calculation and analysis, the stepping motors mounted on different joints of the manipulator are driven respectively. These stepping motors are equal to the joints of humans, and the stepping motor drives the manipulator to move toward the wireless charging receiver, thereby driving the transmitter pad to abut the wireless charging receiver. During the movement of the manipulator to the wireless charging receiver, the laser sensor on the transmitter pad continuously transmits and receives the reflected signal, and the analysis data is continuously converted into the pulse signal for driving the stepping motor until the transmitter pad abuts the wireless charging receiver.

After the transmitter pad and the wireless charging receiver are in the correct position, the transmitter host makes a “click” sound, and the LED light on the transmitter host gives light (for example red light) and flashes at the same time to indicate the electric wheelchair in the charging state. During the charging process, the electric wheelchair user can leave the electric wheelchair. When the battery of the electric wheelchair is fully charged, the LED light gives light (for example green light) and the manipulator automatically returns to the standby position, and then the electric wheelchair user can drive the electric wheelchair away. However, if the electric wheelchair user needs to drive the electric wheelchair to leave during charging, the user needs to press the “stop charging” button set on the transmitter pad to let the manipulator return to the standby position and then drive the electric wheelchair away. When the electric wheelchair leaves the charging parking area, the LED light gives light (for example blue light) to represent the charging standby state.

The present invention automatically searches and moves to the position of the wireless charging receiver by the intelligent manipulator carrying the wireless charging transmitter pad. When the transmitter pad and the wireless charging receiver are aligned, the wireless charging is started. The manipulator automatically returns to the standby position after the charging is completed. During the movement of the manipulator to the wireless charging receiver, the laser sensor on the wireless charging transmitter pad continuously transmits and receives the reflected signal, and the analysis data is continuously converted into pulse signals for driving the stepping motor until the wireless charging transmitter pad moves to abut against the wireless charging receiver to realize the automatic tracking.

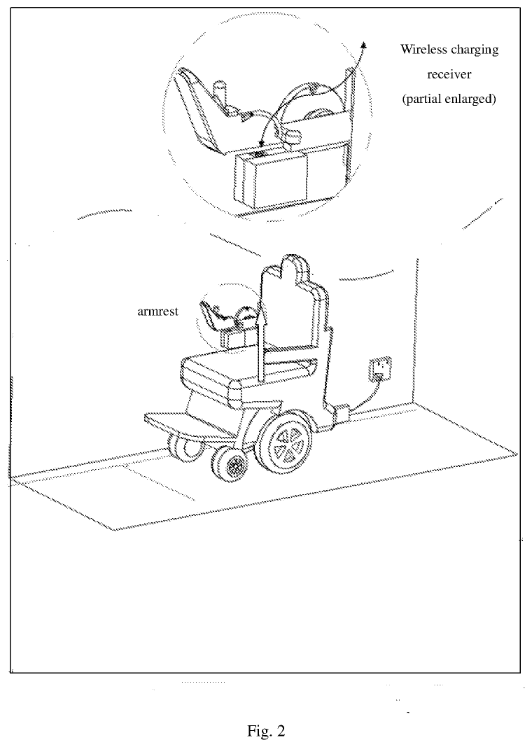

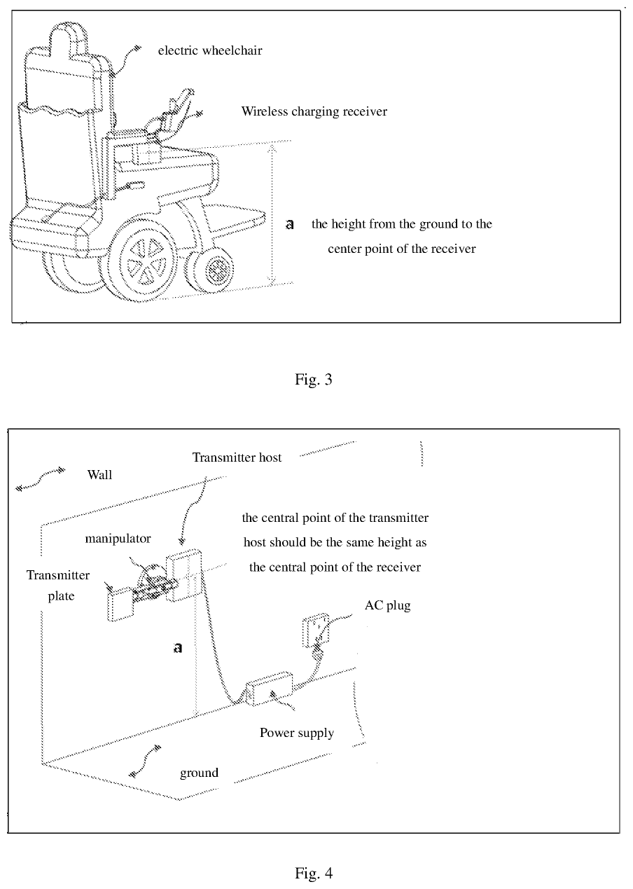

The wireless charging transmitter is mounted on the wall or on the special bracket on the wall. In the present embodiments, this is a one-time initial installation and does not require repeated installation. However, if the height of the seat changes, the initial charging seat height can be adjusted through starting another initial installation. First, the electric wheelchair user needs to adjust the wheelchair seat to the seat comfort height, which is the initial charging seat height during wireless charging. When this height is confirmed, the electric wheelchair seat height must be used every time for wireless charging. Keeping at the same initial charging seat height, otherwise the manipulator do not work properly. The wireless charging receiver is installed in the armrest (for example right armrest, refer to FIG. 2) of the electric wheelchair. Measuring the height of the wireless charging receiver to the ground (refer to FIG. 3). Preferably, the transmitter host is placed in the right armrest. If the transmitter host is set in the left armrest, the extension line is usually added to insert the charging wire plug into the wire socket under the transmitter host. Using the height of the wireless charging receiver to the ground as reference, the height of the center point of the transmitter host should be the same as the height of the center point of the wireless charging receiver (refer to FIG. 4). The transmitter connects to the AC power to make this system work. When pressing the initial installation button on transmitter host, the manipulator extends to the initial installation position and laser transmitter on the transmitter host emits laser lines and draws laser crosshair on the ground.

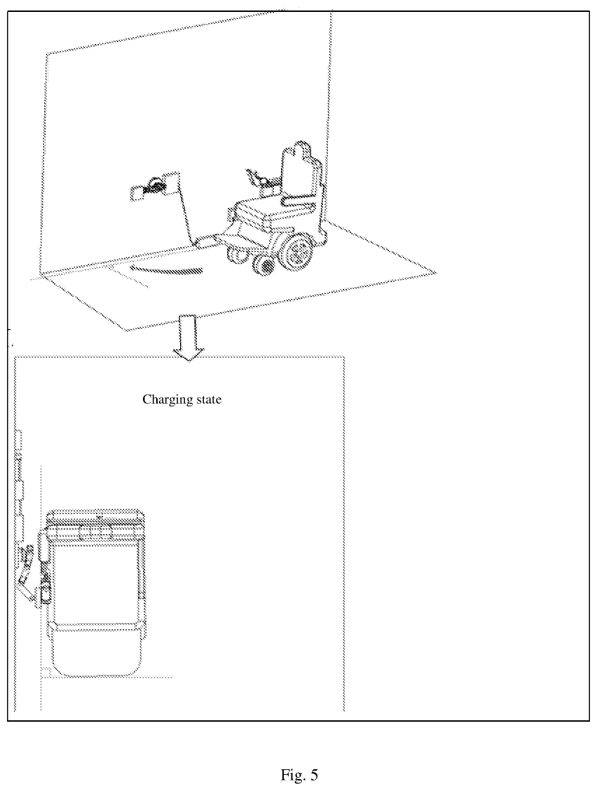

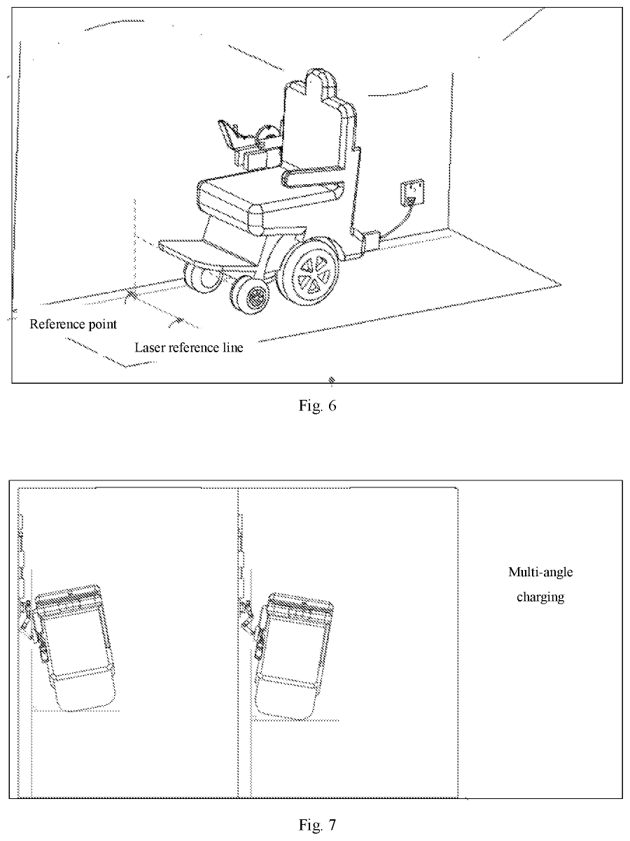

With respect to the transmitter host fixed program, first moving the electric wheelchair close to the location where the transmitter host is installed. Adjusting the position of the electric wheelchair so that the center point of the wireless charging receiver is immersed in the center point of the circular projection plane of the transmitter pad of the manipulator, and adjusting the horizontal position of the manipulator (for example by using the level gauge) and fix the transmitter host on the wall (refer to FIG. 5). Rotating the laser position adjustment knob on the transmitter host to align the laser crosshair with the edge of the front footboard of the electric wheelchair. The laser crosshair drawn on the ground is the parking area for the electric wheelchair (refer to FIG. 6). Pressing the stop charging button on the transmitter pad, the manipulator automatically return to the standby position. The entire system is initially installed and ready for use.

In the present embodiment, there is a LED light on the transmitter host to display the charging status. Wherein red indicates in charging progress; blue represents standby state; green indicates that the battery is fully charged. Of course, there are other colors that can correspond to different functions, and not limited herein.

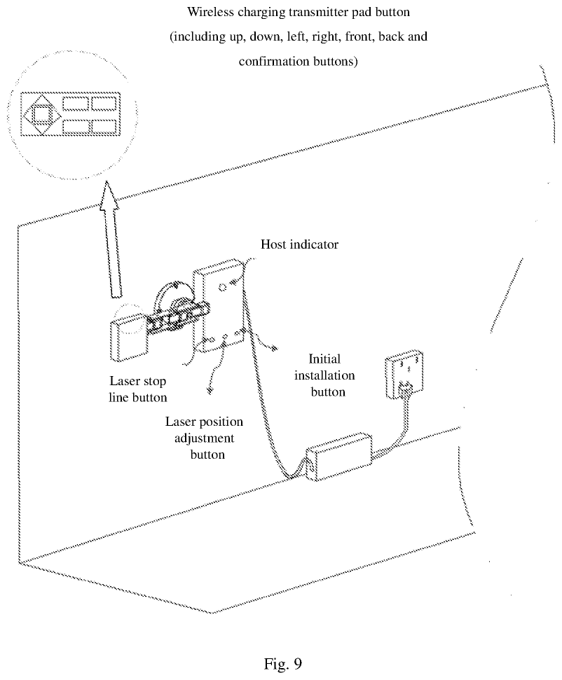

In the present embodiment, the transmitter pad is provided with a stop charging button, a manual charging button, a set of buttons for manipulator (refer to FIG. 9). When the stop charging button is pressed, the wireless charging process is stopped immediately and the manipulator automatically returns to the standby position. When the manual charging button is pressed, the manipulator automatically extend to the waiting for charging position and the electric wheelchair user needs to drive the electric wheelchair to the laser parking reference line. The electric wheelchair user controls the set of buttons for manipulator to manually drive the transmitter pad to move up, down, left, and right, forward and backward, until the circular shaped collar on the transmitter pad abuts the circular shaped depression of the wireless charging receiver.

In the present embodiment, the transmitter host is provided with a laser stop line button, an initial installation button and a laser position adjustment knob. When the laser stop line button is pressed, the red laser parking reference lines are drawn on the ground. When initially installing the transmitter host, the initial installation button is pressed to extend the manipulator to the initial installation position, and the laser transmitter simultaneously emits the laser crosshair. When the laser position adjustment knob is rotated, the laser crosshair can be adjusted during the initial installation process.

In the present embodiment, the wireless charging receiver is provided with a LED light, and its function is to display the battery state of the receiver. If the LED light is flashing, the electric wheelchair is in low battery status and should be charged. The LED light is flashed about a certain time (for example 10 minutes) as a reminder. This reminder is stopped after a certain time (for example 10 seconds of flashing every 10 minutes). The cycle is for about 24 hours. The electric wheelchair user should find transmitter to charge, otherwise the electric wheelchair is out of power and the communication between the wireless charging receiver and the wireless charging transmitter will be interrupted, and the manipulator automatic tracing charging function will not work after the communication is interrupted.

In practical applications, when the electric wheelchair is parked within the parking line, it will more or less tilt forward and backward or at an angle. The parking reference angle of the electric wheelchair can fall within the parking line range to realize the multi-angle charging, for example the parking deviation angle cannot be less than +/−20 degrees. If the electric wheelchair parking status meets the above requirements, manipulator automatically find the center point of the wireless charging receiver through automatic tracking technology. If the parking position exceeds the charging parking area, the transmitter host continuously emits a warning sound or signal since the manipulator cannot work normally. If the electric wheelchair is parked too close to the transmitter host, the manipulator may bump with the electric wheelchair during automatic tracking. The manipulator automatically returns to the waiting for charging position and it needs to operate charging in artificial wireless charging mode. When the manipulator moves, if there is an obstacle, the manipulator will pause the movement and continue to move when the obstacle is far away.

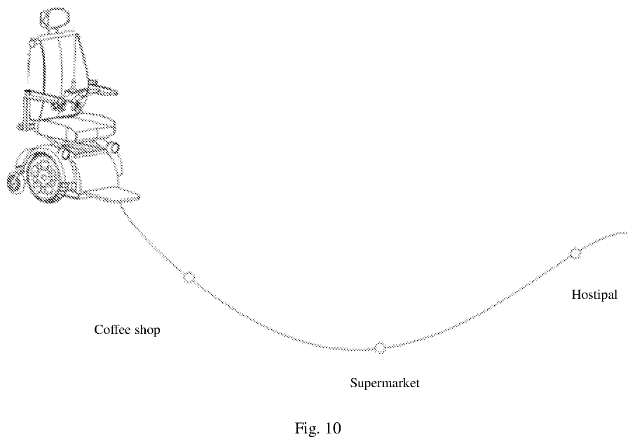

The electric wheelchair battery has limited energy and its cruising range is about 20 kilometers. Because of the need for round-trip, the electric wheelchair user can only move within the radius of 10 kilometers, thus limiting the range of activities of the electric wheelchair user. If the system is installed in various public places, such as libraries, cafes, supermarkets, community clubs, hospitals, etc., the electric wheelchair user can recharge while moving, and the range of activities will be much wider. In the present, the system also can be added to the smartphone APP operating system to achieve charging charges. APP map on the smartphone is used to view the distribution of nearby charging points and its route, etc., so as to make the wheelchair user as ordinary as possible and can free to move around (refer to FIG. 10).

It is to be understood that the embodiment of the present invention which has been described is merely illustrative of one application of the principles of the invention. Numerous modifications may be made to the specific structures and functions used in that embodiment without departing from the true spirit and scope of the invention.

I claim:

1. An intelligent power wireless charging system for electric wheelchairs, comprises:
a wireless charging transmitter connected to power supply, the transmitter has a transmitter host and a manipulator with a transmitter pad;
a wireless charging receiver installed in the electric wheelchair;
when the electric wheelchair is driven to the transmitter host within a certain area, the transmitter host receives the signal from the wireless charging receiver, a laser sensor of the transmitter host detects the position of the electric wheelchair, a laser transmitter of the transmitter host emits reference lines for guiding the electric wheelchair is parked within the predefined charging parking area;
after the electric wheelchair is parked within the charging parking area for a certain time, the manipulator is activated and carries the transmitter pad from the standby position to move to the predefined waiting for charging position;
after the transmitter pad is paused at the waiting for charging position for a certain time, the laser sensor of the transmitter pad is activated and detects the position of the electric wheelchair, the manipulator automatically find the wireless charging receiver to charge through automatic tracking technology;
when the charging is completed, the manipulator automatically returns to the standby position.

2. The intelligent power wireless charging system for electric wheelchairs of claim 1, wherein the transmitter host receives the Bluetooth communication signal from the wireless charging receiver, the laser sensor of the transmitter host emits laser rays, and the laser rays are reflected back to the laser receiver, the time difference between the laser transmitting and receiving signals is to calculate the distance and angle between the transmitter host and wireless charging receiver.

3. The intelligent power wireless charging system for electric wheelchairs of claim 1, wherein the manipulator automatically find the wireless charging receiver, during the movement of the transmitter pad to the wireless charging receiver, the laser sensor on the transmitter pad continuously transmits and receives the reflected signal, and the analysis data is continuously converted into pulse signals for driving the stepping motor until the transmitter pad moves to abut against the wireless charging receiver.

4. The intelligent power wireless charging system for electric wheelchairs of claim 1, wherein the wireless charging transmitter is mounted on the wall or on the special bracket on the wall; the wheelchair seat of the electric wheelchair needs to be adjusted to a height as the initial charging seat height during wireless charging, the wireless charging receiver is installed in the armrest of the electric wheelchair; measuring the height of the wireless charging receiver to the ground and using the height of the wireless charging receiver to the ground as reference, the height of the center point of the transmitter host should be the same as the height of the center point of the wireless charging receiver.

5. The intelligent power wireless charging system for electric wheelchairs of claim 1, wherein the transmitter host has a LED light to display the charging status, wherein the LED light in the first color indicates in charging progress, the LED light in the second color represents standby state, and the LED light in the third color indicates that the battery of the electric wheelchair is fully charged.

6. The intelligent power wireless charging system for electric wheelchairs of claim 1, wherein the transmitter pad comprises a stop charging button, a manual charging button, and a set of buttons for manipulator;
when the stop charging button is pressed, the wireless charging process is stopped and the manipulator automatically returns to the standby position;
when the manual charging button is pressed, the manipulator automatically extends to the waiting for charging position, the electric wheelchair user drives the electric wheelchair according to the laser parking reference lines, and controls the set of buttons for manipulator to manually drive the transmitter pad to move until the transmitter pad abuts the wireless charging receiver.

7. The intelligent power wireless charging system for electric wheelchairs of claim 1, wherein the transmitter host comprises a laser stop line button, an initial installation button and a laser position adjustment knob;
when the laser stop line button is pressed, the laser parking reference lines are drawn on the ground;
when initially installing the transmitter host, the initial installation button is pressed to extend the manipulator to the initial installation position, and the laser transmitter simultaneously emits the parking reference lines;
when the laser position adjustment knob is rotated, the laser parking reference lines can be adjusted during the initial installation process.

8. The intelligent power wireless charging system for electric wheelchairs of claim 1, wherein the wireless charging receiver comprise a LED light to display the battery state of the receiver; if the LED light is flashing, the electric wheelchair is in low battery status.

9. The intelligent power wireless charging system for electric wheelchairs of claim 1, wherein the electric wheelchair is parked within the charging parking area, the parking reference angle of the electric wheelchair is fall within a certain range to realize the multi-angle charging.

10. The intelligent power wireless charging system for electric wheelchairs of claim 9, wherein the electric wheelchair do not move during charging process; or,
if the electric wheelchair needs to be moved during charging, the stop charging button on the transmitter pad is pressed to let the manipulator return to the standby position.
